(19) United States
(12) Patent Application Publication
(10) Pub. No.: US 2008/0300918 A1
(43) Pub. Date: Dec. 4, 2008

(54) SYSTEM AND METHOD FOR FACILITATING HOSPITAL SCHEDULING AND SUPPORT

(75) Inventors: Jay M. Tenenbaum, Portola Valley, CA (US); Allan M. Schiffman, Stateline, NV (US); Kevin Hughes, Honolulu, HI (US); Aytek E. Celik, Mountain View, CA (US)

Correspondence Address: SHEPPARD, MULLIN, RICHTER & HAMPTON LLP, 990 Marsh Road, Menlo Park, CA, 94025, US

(73) Assignee: CommerceNet Consortium, Inc., Palo Alto, CA (US)

(21) Appl. No.: 12/129,537

(22) Filed: May 29, 2008

Related U.S. Application Data
(60) Provisional application No. 60/940,601, filed on May 29, 2007.

(51) Int. Cl. G06Q 50/00

(52) U.S. Cl. 705/2

(57) ABSTRACT

A method comprises enabling a patient to book an appointment via an online service with a particular hospital, the online service providing appointment choices for a number of hospitals, the choices being based on attributes including time, insurance, insurance type, patient concern or geography; sending reminder information to the patient; sending patient information to the particular hospital; sending follow-up questions to the patient after the appointment; providing loyalty points to the patient for completing the follow-up questions; and charging the patient an amount based on various factors for the online service, the various factors including the number of loyalty points the patient has. The method may further comprise using responses to follow-up questions to rate doctors or hospitals.

### PRIORITY CLAIM

This application claims benefit of and hereby incorporates by reference provisional patent application Ser. No. 60/940,601, entitled “Waiting Room,” filed on May 29, 2007, by inventor(s) Tenebaum, Schiffman, Hughes and Celik.

### COPYRIGHT NOTICE

A portion of the disclosure of this patent document contains material which is subject to copyright protection. The copyright owner has no objection to the facsimile reproduction by anyone of the patent document or the patent disclosure, as it appears in the latent and Trademark Office patent file or records, but otherwise reserves all copyright rights whatsoever.

### TECHNICAL FIELD

This invention relates generally to appointment scheduling, and more particularly provides a system and method for facilitating hospital scheduling and support.

### BACKGROUND

Scheduling hospital visits is a time consuming task. Hospitals also find it burdensome. An improved mechanism for scheduling hospital visits would be helpful.

### SUMMARY

In accordance with an embodiment of the present invention, a method comprises enabling a patient to book an appointment via an online service with a particular hospital, the online service providing appointment choices for a number of hospitals, the choices being based on attributes including time, insurance, insurance type, patient concern or geography; sending reminder information to the patient; sending patient information to the particular hospital; sending follow-up questions to the patient after the appointment; providing loyalty points to the patient for completing the follow-up questions; and charging the patient an amount based on various factors for the online service, the various factors including the number of loyalty points the patient has. The method may further comprise using responses to follow-up questions to rate doctors or hospitals.

### BRIEF DESCRIPTION OF THE DRAWINGS

FIG. 1 shows patient flow for a specific physician/lab in accordance with an embodiment of the present invention.

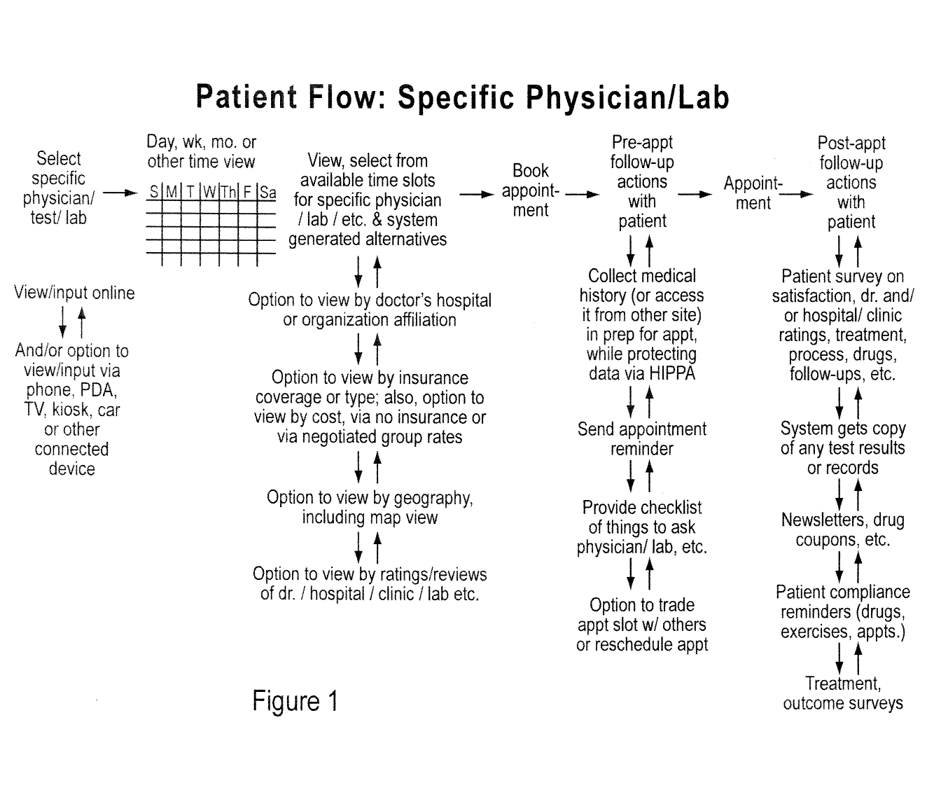

FIG. 2 shows patient flow for a physician/lab type in accordance with an embodiment of the present invention.

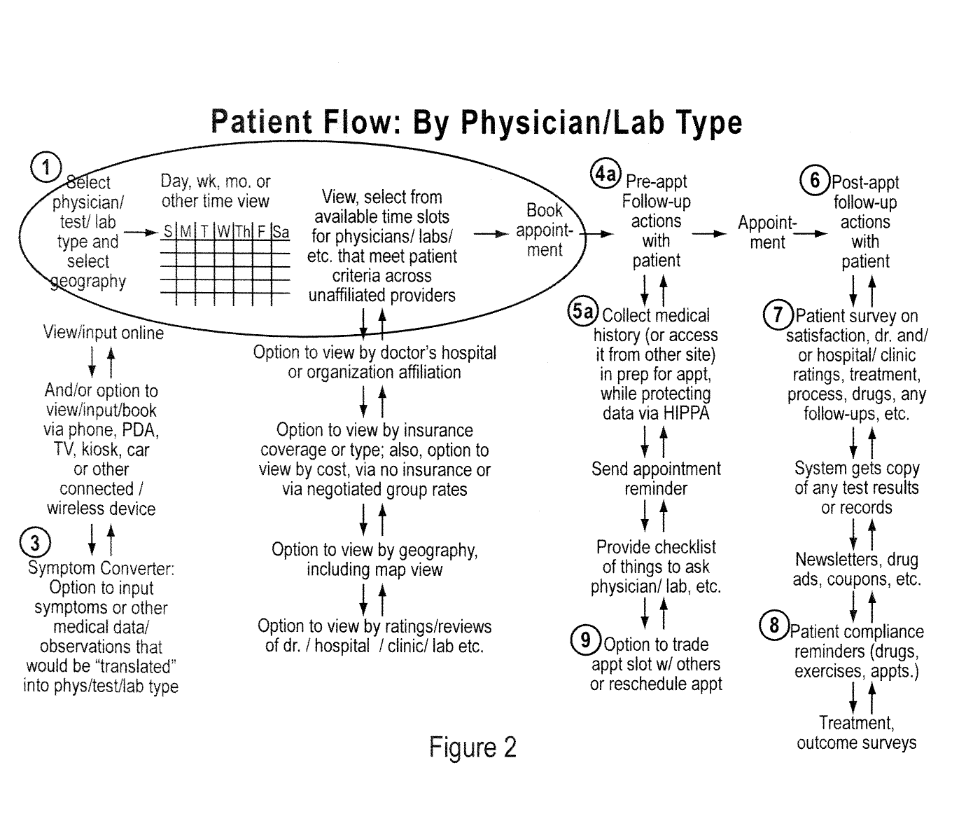

FIG. 3 shows receptionist/business-office flow in accordance with an embodiment of the present invention.

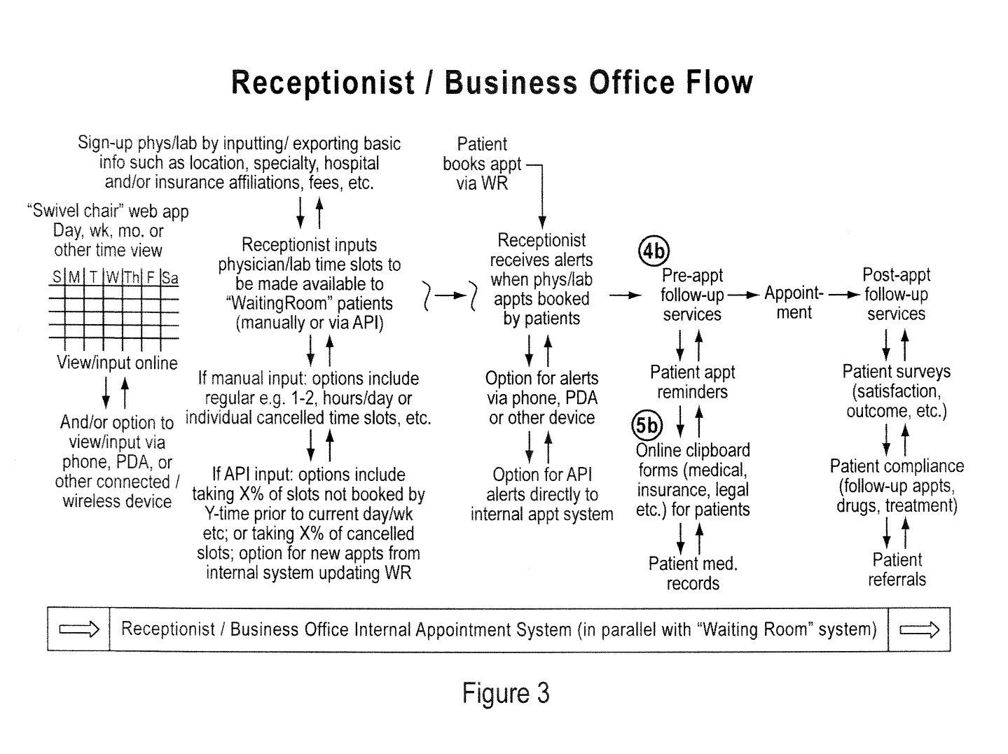

FIG. 4 shows physician/nurse flow in accordance with an embodiment of the present invention.

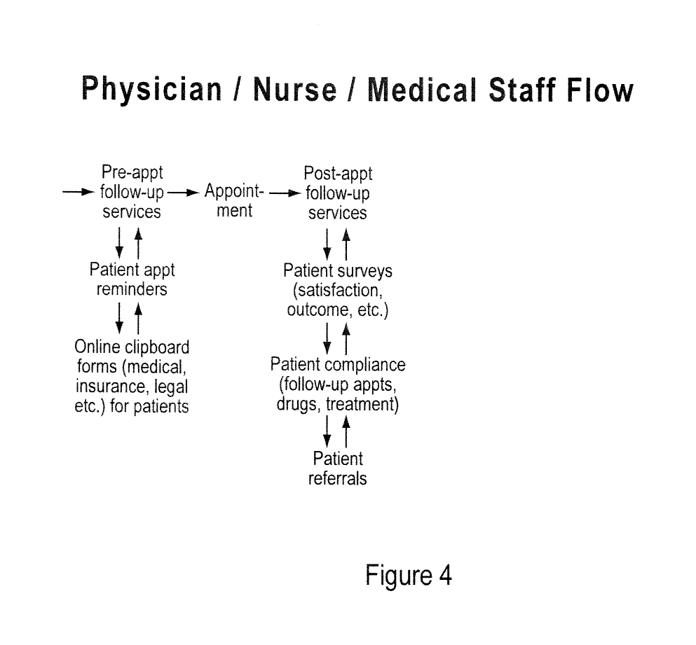

FIG. 5 shows business model/process details in accordance with an embodiment of the present invention.

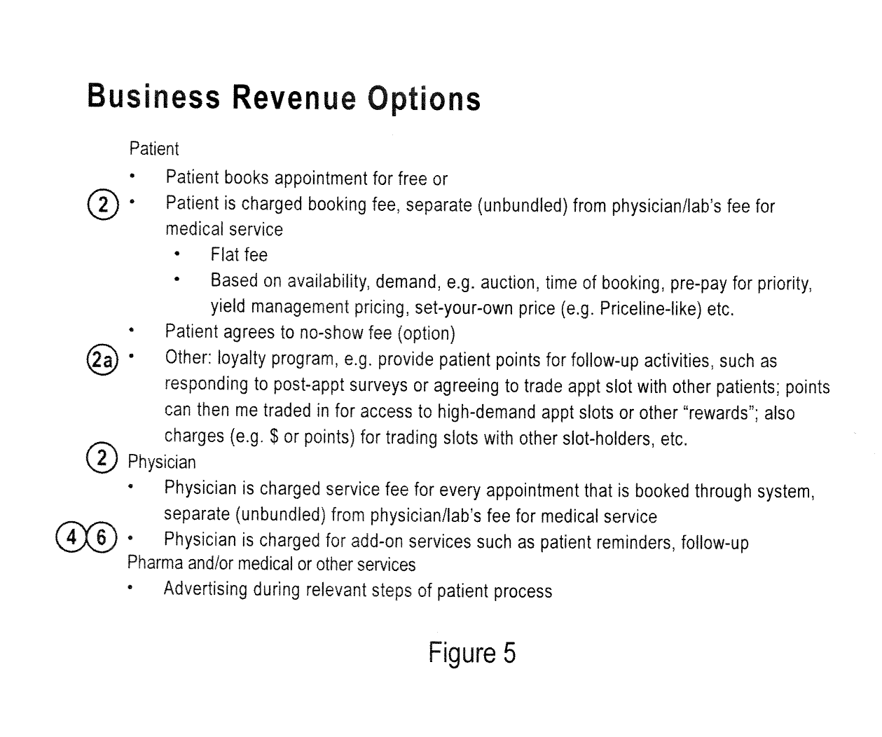

FIG. 6 shows details of the system in accordance with an embodiment of the present invention.

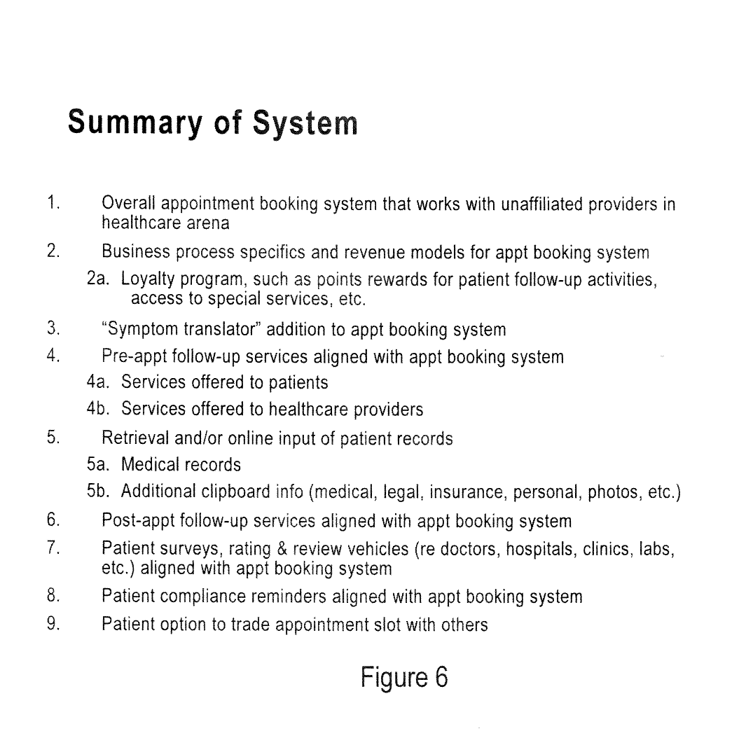

### DETAILED DESCRIPTION

The following description is provided to enable any person skilled in the art to make and use the invention. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

In accordance with an embodiment of the present invention, a method comprises enabling a patient to book an appointment via an online service with a particular hospital, the online service providing appointment choices for a number of hospitals, the choices being based on attributes including time, insurance, insurance type, patient concern or geography; sending reminder information to the patient; sending patient information to the particular hospital; sending follow-up questions to the patient after the appointment; providing loyalty points to the patient for completing the follow-up questions; and charging the patient an amount based on various factors for the online service, the various factors including the number of loyalty points the patient has. The method may further comprise using responses to follow-up questions to rate doctors or hospitals.

1. Appointment Booking System that Works with Unaffiliated Providers in Healthcare Arena

Project “WaitingRoom” (WR) is a system that allows patients to find and book health-care related appointments (physicians, specialists, labs, tests, hospital stays, other healthcare related therapies) via the Web for one or more unaffiliated healthcare providers (e.g. providers across different organizations).

Access to WR may also be available via phone, PDA, TV, kiosk, car or other Internet connected or wireless device.

WR enables patients to promptly find a physician (or lab etc.) that meets the needs of the patient's schedule and potentially captures the patient's preferences for a specific provider or type of specialist, location, facility, payment options, insurance options, physician/facility ratings/reviews by other patients, physician/lab provided data, etc.

WR may also provide additional services in booking appointments via “translating” the patient's reported symptoms into (a) type(s) of healthcare provider(s). [Listed as #3]

From a different viewpoint, WR enables healthcare providers (doctors, labs, etc.) to fill empty/cancelled appointment slots without necessarily interfering with the healthcare providers' internal appointment system.

### 2. Business Process Specifics and Revenue Models for Appointment Booking System

The WR business allows the patient to book appointments for a fee (or in some cases, at no charge), that is separate (unbundled) from the physician/lab's fee for the medical service. In other words, the appointment slots themselves are “rights.” The patient fee could be based on appointment availability, overall patient demand (e.g. auction based or otherwise), time of booking (e.g. higher fee for same day or next day appointments), pre-pay for priority, yield management pricing, set-your-own price (e.g. Priceline-like) etc. Patients may also be charged a no-show fee for not following through on appointments booked via WR.

Another option is to charge the physician/lab/etc. a fee for every appointment that is booked through WR. Again, this fee is separate (unbundled) from the physician/lab's fee for medical service.

The physician/lab could also be charged for add-on services such as patient appointment reminders, follow-up activities including patient compliance (re drugs, treatment, appointments, etc.) and other services.

Other business revenue options for the WR project include advertising to patients and/or healthcare providers during relevant steps of the patient or provider process flows. Potential advertisers include Pharma industry players and/or medical services or other relevant products and services. Potential advertising vehicles include “push” ads (e.g. Web search or banner ads or newsletter ads) or patient/provider-triggered ads (e.g. request for more “info” on drugs).

2a. Loyalty Program, such as Points Rewards for Patient Follow-up Activities, Access to Special Services etc.

In addition, WR may otter a loyalty program to patient and/or healthcare provider participants. WR may reward/motivate patients by providing patients with “points” for their follow-up activities, such as responding to post-appointment surveys or agreeing to trade appointment slots with other patients. Patients could use these points for access to high-demand appointment slots (e.g. by time, provider, etc) or other “rewards.” Also patients could be charged ($ or points) to trade their current slot with other slot-holders, etc.

### 3. “Symptom Translator” Addition to Appointment Booking System

[See Description at end of #1]

4. Pre-appointment Follow-up Services Aligned with Appointment Booking System

4a. Services Offered to Patients

4b. Services Offered to Healthcare Providers

Once a patient books an appointment, WR follows up with the patient and the healthcare provider to confirm the appointment and/or provide additional services. Prior to the patient fulfilling the appointment, WR may offer services to the patient such as appointment reminders (via a default or patient-preferred communication vehicle such as phone or email), or customizable checklists of things for the patient to ask the physician/lab at the appointment.

5. Retrieval and/or Online Input of Patient Records

5a. Medical Records

5b. Additional Clipboard info (Medical, Legal, Insurance, Personal, Photos, etc.)

WR may also provide patients with an online medical history form that they can fill out (or update - for returning WR patients) prior to the appointment, and which can then be electronically sent to the healthcare provider prior to (or in time for) the actual appointment. Alternatively, WR could access the patient's electronic medical record from another site or organization (with the patient's permission) and then send that record to the healthcare provider for the upcoming appointment. All medical record related services would include HIPPA provisions as appropriate.

From the perspective of the healthcare provider, WR offers a similar set of pre-appointment services. These could include patient appointment reminders, online clipboard forms (medical, insurance, legal, personal history, photos, etc.) for patients to fill out prior to their appointments and/or requests to new patients for past medical records and/or histories. Again, all such patient data services would include HIPPA provisions as appropriate.

WR may also provide patients with the option to reschedule their appointment times and/or trade their appointment slots with other patients. [Listed as #9]

6. Post-appointment Follow-up Services Aligned with Appointment Booking System

After the patient fulfills the appointment, WR may offer another set of services to the patient or the healthcare provider. These services include newsletters and/or advertisements sent to the patient by WR, either associated with the health care provider or not.

7. Patient Surveys, Rating & Review Vehicles (re Doctors, Hospitals, Clinics, Labs, etc.) Aligned with Appointment Booking System

Another potential service is the post-appointment patient survey. This could range from the patient's satisfaction ratings and reviews of the physician/lab/hospital/clinic/etc, to feedback on the medical or appointment process, prescriptions, follow-up actions, etc. One particular type of survey follow-up is the patient treatment and outcome survey. Over time, this collective data could provide an input stream for evidence based medicine, and could be leveraged for other services, internal to WR or outsourced.

8. Patient Compliance Reminders Aligned with Appointment Booking System

Patient compliance reminders are another service that WR may provide. This could be offered as a service directly to patients, or it could be a sponsored (editorially, monetarily or otherwise) service by the healthcare provider for the patient. Patient compliance services could include reminders for appointments, taking medication or doing physical therapy, or other treatment options.

9. Patient Option to Trade Appointment Slot with Others. [See Description at End of #5.]
Why appointment asap?
Medical Need
   Specialist
   Testing (MRI, labs)
Convenience
   Time (see available times)
   Location (see available locations)

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
enabling a patient to book an appointment via an online service with a particular hospital, the online service providing appointment choices for a number of hospitals, the choices being based on attributes including time, insurance, insurance type, patient concern or geography;
sending reminder information to the patient;
sending patient information to the particular hospital;
sending follow-up questions to the patient after the appointment;
providing loyalty points to the patient for completing the follow-up questions;
charging the patient an amount based on various factors for the online service, the various factors including the number of loyalty points the patient has.

2. The method of claim 1, further comprising using responses to follow-up questions to rate doctors or hospitals.
